(19) United States
(12) Patent Application Publication
(10) Pub. No.: US 2008/0144991 A1
(43) Pub. Date: Jun. 19, 2008

(54) Optical Transmission System Via Polarization-Maintaining Fibres

(75) Inventor: Denis Penninckx, Cestas (FR)

Correspondence Address: THELEN REID BROWN RAYSMAN & STEINER LLP, P. O. BOX 640640, SAN JOSE, CA, 95164-0640, US

(73) Assignee: COMMISSARIAT A L'ENERGIE ATOMIQUE, Paris (FR)

(21) Appl. No.: 11/660,228

(22) PCT Filed: Aug. 10, 2005
(86) PCT No.: PCT/FR05/50666

§ 371 Date: Feb. 13, 2007

(30) Foreign Application Priority Data
Aug. 16, 2004 (FR) 0451854
Oct. 21, 2004 (FR) 0452395

(51) Int. Cl. G02B 6/24

(52) U.S. Cl. 385/11

(57) ABSTRACT

The invention concerns a polarization-maintaining fiber-optic transmission system. The invention concerns a fiber-optic transmission system comprising at least one polarization maintaining fiber coupling an input device to an output device. The fiber comprises at least a first (F1) and a second (F2) polarization maintaining fiber section having each a slow propagation axis and a fast propagation axis. One end of the first fiber section is coupled to one end of the second fiber section such that the slow propagation axis of the first fiber section coincides with the fast propagation axis of the second fiber section and inversely. The invention is applicable in particular to lasers.

The invention concerns an optical transmission system via polarization-maintaining fibres. It applies to transmission techniques of optical signals using one or more polarization-maintaining fibres. These signals may be laser pulses in power lasers, or signals conveying data in telecommunications systems.

Polarization-maintaining fibres, as their name indicates, allow the transmission of a signal whilst preserving its polarization. They are characterized by two axes called <<slow>> and <<fast>>. The connectors of optical fibres induce stresses on polarization-maintaining fibres which slightly modify the polarization state of the signal. This modification, associated with the difference in speed between polarization states inside polarization-maintaining fibres, generates signal distortions. These distortions, most handicapping and arbitrary, are known under the name FM-AM conversion with respect to power lasers.

In the area of data transmission by optical fibres such as in telecommunications, the problem has not been raised up until now since polarization-maintaining fibres are little used for cost reasons. However these fibres would make it possible to double the capacity of optical fibres. It is not impossible that, in the future, this solution may be used for very short distance links (local networks for example) requiring extremely high bit rates.

In the area of power lasers, to overcome these distortions, different solutions have been put forward of which none is fully satisfactory. They particularly relate to:
replacing polarizing-maintaining fibres by polarizing fibres;
replacing polarizing-maintaining fibres by conventional fibres;
replacing polarizing-maintaining fibres by propagation in free space,
adding polarizers regularly distributed along the transmission circuit.

These different solutions have disadvantages. The addition of polarizers between sections does not fully eliminate the phenomenon but achieves its attenuation at the cost of complexity and increased expense.

All the other solutions completely eliminate FM-AM conversion due to the propagation of a polarized signal in the fibres. But:
polarizing fibres are very difficult to bond and are very sensitive to microbending. They must therefore be packaged in most specific manner.
conventional fibres do not control polarization. A polarization controller is required. This solution is very difficult to implement, especially when several controllers need to be cascaded in the chain. In addition, these controllers are expensive, generate some additional losses and are not necessarily reliable.
propagation in free space requires excellent stability and most accurate alignment of the different optical devices.

The invention concerns a system making it possible to solve these difficulties.

The invention therefore concerns an optical fibre transmission system of a polarized signal comprising at least one system with polarization-maintaining optical fibres allowing the polarization of the signal to be maintained. This optical fibre system comprises at least a first and a second section of polarization-maintaining fibre, each having a slow propagation axis and a fast propagation axis. One end of the first fibre section is coupled to one end of the second fibre section, such that the slow propagation axis of the first fibre section is coincident with the fast propagation axis of the second fibre section, and conversely such that the fast propagation axis of the first fibre section is coincident with the slow propagation axis of the second fibre section. Therefore in said system the global differential group delay of one or more sections is equal to the global group delay of the other sections, so that the global differential group delay of said optical fibre system is substantially zero.

Preferably, the system of the invention comprises a first and a second fibre section, the two fibre sections having equivalent differential group delays.

Advantageously, the two fibre sections are fabricated in one same fibre.

It may also be of particular interest to provide for the two fibre sections to have the same length.

Provision may also be made for a plurality of pairs of sections.

In particular, provision may be made for a plurality of fibre sections coupled in series, each section being connected in series with the adjacent section so that the slow propagation-axis of each fibre section is coincident with the fast propagation axis of the adjacent fibre section, the intermediate sections of the series of sections each having a differential group delay equal to a determined value, whilst the first and last section of the series of sections each have a differential group delay equivalent to one half of this determined value.

In practice, this could be achieved by providing for intermediate sections which each have a determined length, and the first and last section each have an equivalent length equal to one half of this determined length.

Regarding the coupling of the fibre sections, according to one embodiment the end of the first fibre section is coupled to the end of the second fibre section by bonding these ends.

According to one variant of embodiment, the end of the first fibre section is coupled to the end of the second fibre section by a connect device.

According to one embodiment particularly applicable to telecommunications, the system of the invention comprises an input device, an output device and a polarization rotator associated with the input device or the output device and making it possible to rotate the polarizations of the signals transmitted to said optical fibre system by an angle corresponding to the sum of polarization rotations induced by the optical fibre system and in the opposite direction of the sum of these rotations.

The different objects and characteristics of the invention will become more apparent in the following description and appended figures in which:

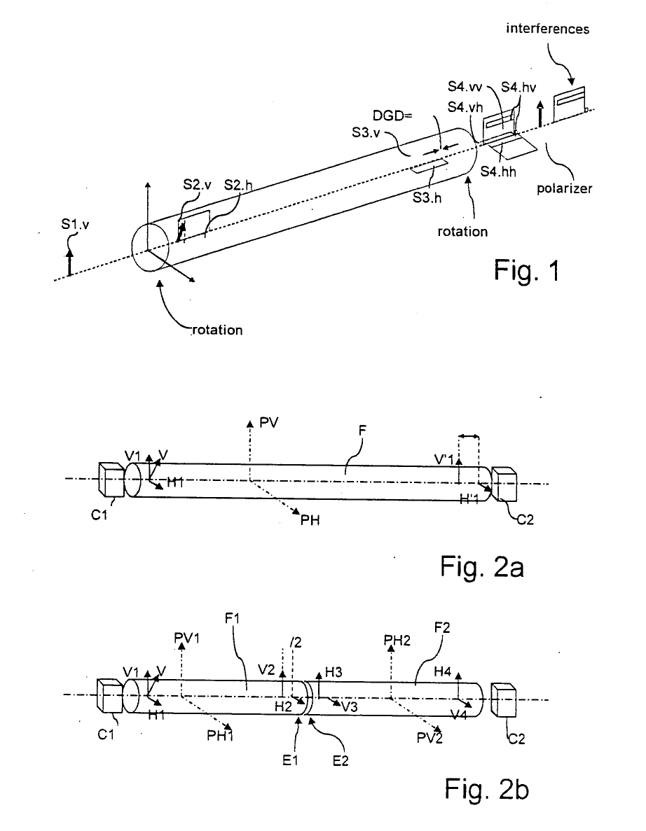

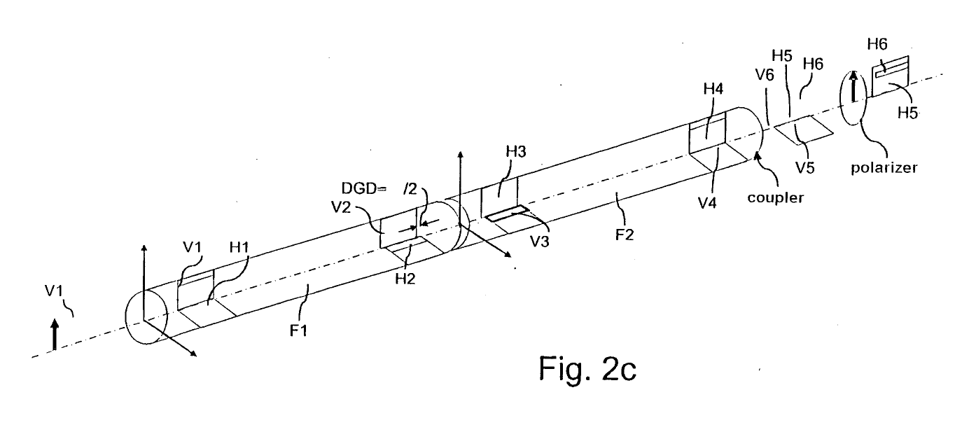

FIGS. 1 and 2a are diagrams explaining the consequences of the polarization rotations to which an optical signal is subjected, this signal being transmitted in a polarization-maintaining fibre,

FIG. 2b schematically illustrates an example of embodiment of the system of the invention,

FIG. 2c shows the system in FIG. 2b according to the same illustration mode as in FIG. 1,

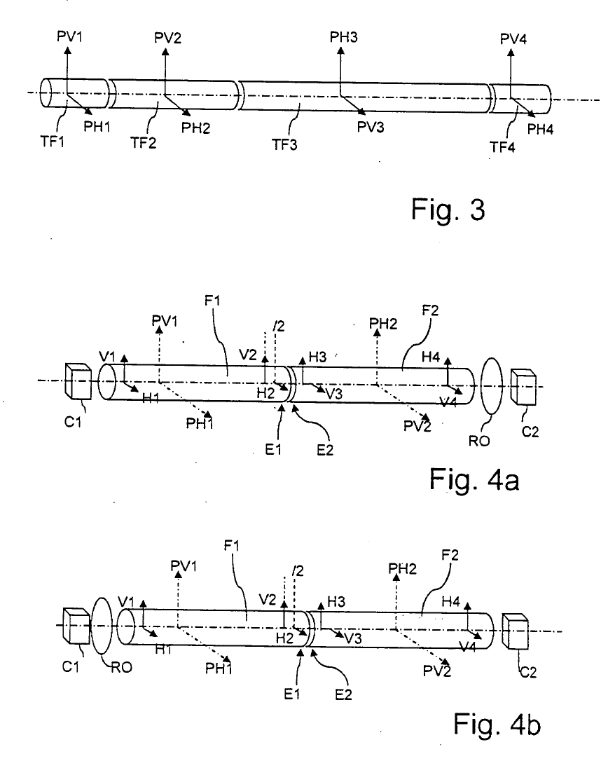

FIG. 3 schematically illustrates a variant of embodiment of the system of the invention,

FIGS. 4a and 4b schematically illustrate an example of application of the system of the invention to a transmission system for telecommunications signals, and

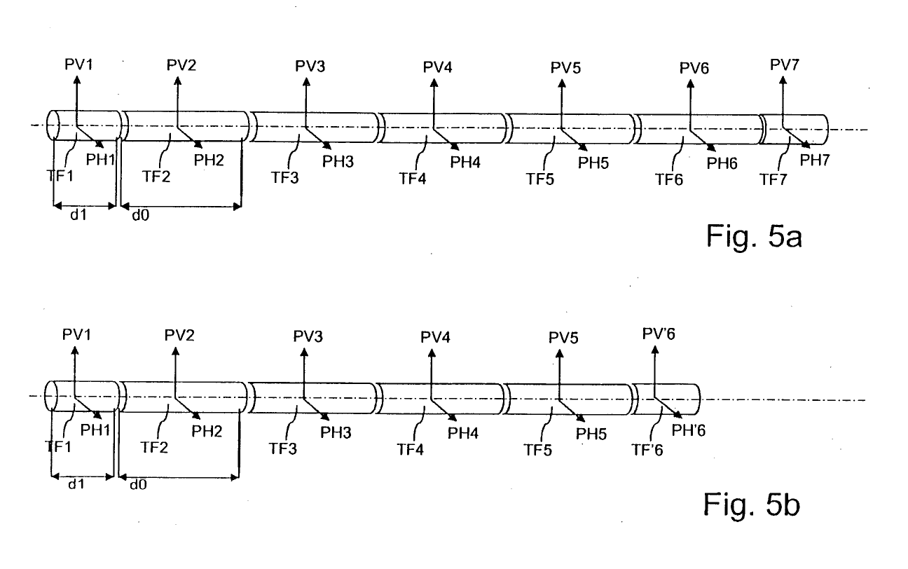

FIGS. 5a and 5b show variants of embodiment of the optical fibre transmission system according to the invention.

Polarization-maintaining fibres, as their name indicates, allow the transmission of a signal whilst preserving its polarization, provided that the polarization state of the incident signal follows one of the two so-called own or main axes of the polarization-maintaining fibre. These two axes are called <<slow>> and <<fast>> and the difference in arrival time is called the Differential Group Delay—DGD.

Any stress exerted on a polarization-maintaining optical fibre modifies the polarization states of the optical signals transmitted on these fibres. The connectors of optical fibres, in particular, induce stresses on these polarization-maintaining fibres.

Owing to the difference in speed between the two optical polarization axes of a polarization-maintaining fibre, this modification is dependent upon optical frequency. Therefore the spectral components of the signal no longer have the same polarization state when leaving a polarization-maintaining fibre which is subjected to stresses, and in particular fibres equipped with connectors.

If provision is made for a polarizer, the optical signal passes through the polarizer and the spectral components of the signal are not all transmitted similarly. This differential attenuation of the spectral components generates signal distortions. With power lasers, these distortions are known under the name FM-AM conversion.

This spectral image of the phenomenon can be illustrated by FIG. 1. If a signal S1v is injected onto one of the axes of the polarization-maintaining fibre, its polarization state is slightly angled after the input connector. Rotation is very small (a few degrees) but sufficient to generate the phenomenon. The projections S2.v and S2.h of the signal on the two axes propagate at different speeds. For example, it can be seen in FIG. 1 that the signals S3.v and S3.h are shifted by a time Δτ, called Differential Group Delay—DGD.

At the output, the signal again undergoes a rotation on account of the second connector. The polarization component S3.v gives rise to two components S4.vv and S4.vh. The polarization component S3.h gives rise to signals S4.hh and S4.hv which, in FIG. 1, is shown in two parts on account of the time shift between the signals propagating along the two polarization axes of the fibre.

If only one polarization state is kept (through a polarizer for example) interferences will be seen between the two above-mentioned projections such as S4.vv and S4.hv in FIG. 1.

With power lasers, when the signal is solely phase-modulated (FM) at the input, this translates as an intensity-modulation at the output (AM). In telecommunications, the signal will be distorted which will limit the range of the system.

The invention provides a solution to this problem.

FIG. 2a shows a polarization-maintaining optical fibre F, in which an optical coupler C1 allows the injection of a polarized light signal V. The polarizations of the fibre F are symbolized in FIG. 2a by PV and PH. The entry of signal V into the fibre via the coupler is the subject of a slight polarization rotation, and it is therefore signal Vr which is transmitted in the fibre. This signal Vr can decompose into two components V1 and H1 along the two directions of polarization of the fibre. Component H1 propagates faster in the fibre than component V1, and component H′1 reaches the output end of the fibre, towards coupler C2, in a time Δτ before component V′1.

According to the invention, provision is made to form the fibre in two sections of polarization-maintaining fibre, F1 and F2 (FIG. 2b). According to one advantageous example of embodiment of the invention, the two sections are designed to have the same length. By comparison with FIG. 2a, they each correspond to one half of the length of fibre F. In addition, the ends E1 and E2 of these two fibre sections are coupled so that the slow and fast propagation axes PV1 and PH1 of section F1 are coincident with respectively the fast and slow propagation axes PH2 and PV2 of section F2.

As previously, the signal V entering into fibre section F1 gives rise to two components V1 and H1 which propagate at different speeds. Component H2 propagates along the fast axis and reaches the other end of section F1 before component V2 which propagates along the slow axis. Having previously provided that the lengths of fibre sections F1 and F2 are equal to one half of the length of the fibre F, component H2 reaches the end of section F1 in a time Δτ/2 before component V2.

The propagation axes PV1 and PH1 of fibre section F1 being respectively coupled to the propagation axes PH2 and PV2 of section F2, it can be considered that the signal corresponding to component V2 in section F1 is found in section F2 in the form of a component H3. Similarly, component H2 is found in the form of component V3. Component H3 now propagates along the fast axis and component V3 along the slow axis. It follows that component H3 will catch up on the delay Δτ/2 it showed with respect to component V3. The two components H4 and V4 therefore arrive at the same instant at the output end of fibre section F2. This evidently assumes that the two fibre sections F1 and F2 have the same characteristics.

FIG. 2C shows the system of FIG. 2b in the same representation mode as in FIG. 1. It can be seen that at the output of fibre section F2, components H4 and V4 are in phase. If, at the output of section F2 a coupler is provided, the signals will again be the subject of a slight polarization rotation. Component H4 gives rise to components H5 and V6 and component V4 gives rise to components V5 and H6. After passing through a polarizer, components H5 and H6 are obtained which are in phase.

Under these conditions, according to the invention, in a transmission system with polarization-maintaining fibres, provision is made for a fibre link in at least two sections, as just described, between two couplers or between two fibre stress zones, or between a stress zone and a coupler.

According to one simplified embodiment, it is also possible to provide for the orientations of the sections to be chosen arbitrarily. If the number of sections is high, FM-AM conversion decreases. For example FIG. 3 shows an example of embodiment in which fibre sections TF1 and TF2 are coupled with the slow axes PV1 and PV2 of the two sections in coincidence, and the fast axes PH1 and PH2 in coincidence. Fibre section TF3 is coupled with section TF2 having its fast axis PH3 coincident with the slow axis PV2 of section TF2, and its slow axis PV3 coincident with the fast axis PH2 of section TF2. Fibre section TF4 is oriented in the same manner as sections TF1 and TF2 and is coupled to section TF3 having its slow axis PV4 coincident with the fast axis PH3 of section TF4, and its fast axis PH4 coincident with the slow axis PV3 of section TF3. As can be seen FIG. 3, the fibre sections can be of different lengths and may possibly not be regularly arranged. The essential point is that, in a determined transmission system, the global differential delay (propagation difference along the slow and fast axes) of one or more sections is compensated by the differential delay of the other sections. In the system shown FIG. 3 therefore, the total differential delay of sections TF1, TF2 and TF4 is compensated by the differential delay of section TF3.

Nonetheless, a true alternation is preferable. An analytical model developed for this purpose proves that, after the differential delay DGD of each section, it is effectively the DGD of the consecutive sections which is the most important. Digital simulations also confirm these predictions.

Compensation of the differential delay (Δτ) of one section by the differential delay of another section is more effective the more the differential delays are near-equal. It is therefore better to have sections of similar lengths.

Finally, to avoid polarization rotations between two sections which have to compensate one another, one preferred embodiment of the invention consists of bonding the sections, but coupling of the fibre sections by connectors is a possible embodiment.

In practice, starting with an already assembled optical fibre system, all that is required is to cut the polarization-maintaining fibres into fibre sections exactly in their centre, and then to re-bond them at 90°. This operation is easy to perform.

FIGS. 5a and 5b shows variants of embodiment of a transmission system in which there are three or more sections, and the length of one of the sections located in an intermediate position is a length d0 imposed by stresses which lie outside the scope of the invention. According to the invention, it is then provided that the lengths of the intermediate sections are equal to d0 and that the end sections have lengths d0/2 that are one half of this length.

By way of example FIG. 5a shows a system comprising an uneven number of fibre sections, e.g. seven sections TF1 to TF7. The intermediate sections TF2 and TF6 each have a determined differential group delay. The end sections TF1 and TF7 are similarly constituted and each have a differential group delay which is one half of the delay of the intermediate sections TF2 to TF6.

For practical purposes, if these sections are made from fibres of the same type, even from the same fibre, the system in FIG. 5a is therefore made with intermediate sections TF2 to TF6 of a determined length d0 and with end sections TF1 and TF76 of half lengths d1=d0/2.

The differential group delay of fibre section TF2 is compensated, for example, by the differential group delay of section TF3. That of fibre section TF4 is compensated by the group delay of section TF5, and that of section TF6 is compensated by the sum of the differential delays of sections TF1 and TF7.

Therefore it should be noted that the global differential group delay of sections TF2, TF4 and TF6 is compensated by the global differential group delay of sections TF1, TF3, TF5 and TF7. This effectively gives a transmission system with which it is possible to cancel out the global differential group delay of the system.

FIG. 5b shows a system comprising an even number of fibre sections, six sections TF1 to TF6 for example.

As in the example in FIG. 5a, the intermediate sections TF2 to TF5 each have a determined differential group delay. The end sections TF1 and TF6 are similarly constituted and each have a group delay which is one half of the delay of the intermediate sections TF2 to TF5. For example, the fibre sections TF2 to T5 have a length d0, and sections TF1 and TF6 have a length d1=d0/2.

The sum of the differential group delays of fibre sections TF2 and TF4 is compensated by the sum of the differential group delays of sections TF3 and TF5. The differential group delay of fibre section TF1 is compensated by the differential group delay of section TF6. We therefore also have a transmission system enabling cancellation of the global differential group delay of the transmission system.

Therefore, whether the number of sections is even or uneven, we have a transmission system which maintains polarization if the end sections have equivalent differential group delays, and if the end sections each have a transmission time equivalent to one half of the differential group delay of an intermediate section.

However, this variant of the invention is of especial interest when the number of sections is uneven, since it often occurs that it is advantageous in a transmission system to have the same polarizations propagating at the input and output along the same axes (slow and fast) of transmission.

It can be seen therefore that the invention chiefly consists of inverting the axes of the polarization-maintaining fibres to compensate the speed differences of the polarization components of a signal. These inversions may be arbitrary, but provision may also be made for alternate sections of same length.

If provision is made for sections having the same length, advantageously the section lengths at the two ends of the system have one half of this length. According to the type of system, stresses may be imposed such as the total length of the optical fibre system or the number of sections. It is therefore the analytical model or a digital simulation which can determine the number of fibre sections and their lengths.

Further advantageously the sections are bonded in pairs without stress, and not linked by connectors.

It is to be noted that these inversions of the axes of the fibre sections are not intended to achieve filtering, or to make a sensor or an optical system independent of the polarization state of an incident signal. On the contrary, according to the invention, the aim is to apply this technique to the conveying of a polarized signal, maintaining its polarization whilst avoiding distortions.

This was not obvious for persons skilled in the art, since the conveying of a polarized signal merely requires maintaining polarization and does not entail taking into account <<leakages>> on the orthogonal axis (due to rotations at the connectors).

In other words, the object of the invention is to maintain polarization and not to make a physical process independent of the polarization state of the signal. It was not obvious a priori that alternating the axes of a fibre could be useful just for conveying a signal.

Simulations have shown that in a system according to the invention, FM-AM conversion is practically eliminated and the polarization state is maintained as in a polarizing fibre. But, unlike a polarizing fibre, the bonding between polarization-maintaining fibres is easy, and sensitivity to losses by microbending is near-zero. Finally this solution is low cost.

The invention applies more particularly to any fibre-conveying of a signal in which it is desired to maintain the polarization state of the signal. The invention applies directly to power lasers, but also to the area of telecommunications.

In a telecommunications system, it would be of interest to transmit polarized signals in two orthogonal polarization directions to double transmission capacities. However, owing to polarization rotations due to stresses which may exist in the fibres and due to coupling devices, part of a signal polarized in one direction risks being polarized in the other direction, and hence will disturb a signal propagating at the same time at a very close wavelength and which is polarized in this other direction.

To overcome this shortcoming, as shown FIGS. 4a and 4b, provision is made for a polarization controller or a rotator of polarization directions RO, whose role is to rotate the polarizations of the transmitted signals by an angle corresponding to the sum of polarization rotations which these signals will undergo in the transmission system. The rotation induced by rotator RO will be made in the opposite direction to the global rotation induced in the transmission system.

In FIG. 4a the polarization rotator RO is placed at the output of the system and is associated with the coupler C2 for example. In FIG. 4b, it is placed at the input to the system.

1. System for optical fibre transmission of a polarized signal, comprising a system with polarization-maintaining optical fibres, this system enabling the polarization of the signal to be maintained, said optical fibre system comprises at least a first and a second section of polarization-maintaining fibre, each having a slow propagation axis and a fast propagation axis, one end of the first fibre section being coupled to one end of the second fibre section such that the slow propagation axis of the first fibre section is coincident with the fast propagation axis of the second fibre section, and conversely such that the fast propagation axis of the first fibre section is coincident with the slow propagation axis of the second fibre section, the global differential group delay of one or more sections being equal to the global group delay of the other sections, so that the global differential group delay of said optical fibre system is substantially zero.

2. Transmission system according to claim 1, comprising a first and a second fibre section, the two fibre sections having equivalent differential group delays.

3. Transmission system according to claim 2, wherein the two fibre sections are fabricated in one same fibre.

4. Transmission system according to claim 2, wherein the two fibre sections have the same length.

5. Transmission system according to claim 2, comprising a plurality of pairs of sections.

6. Transmission system according to claim 1, comprising a plurality of fibre sections (TF1 to TF7) connected in series, each section being coupled in series with the adjacent section such that the slow propagation axis of each fibre section is coincident with the fast propagation axis of the adjacent fibre section, the intermediate sections (TF2 to TF6) of the series of sections each having a differential group delay equal to a determined value, whilst the first and last section (TF1 and TF7) of the series of sections each have a differential group delay equivalent to one half of said determined value.

7. Transmission system according to claim 6, wherein the intermediate sections each have a determined length (d0), and the first and last sections each have a length equivalent to one half (d1=d0/2) of said determined length.

8. Transmission system according to claim 1, wherein the end of one first fibre section is coupled to the end of a second fibre section by bonding these ends.

9. Transmission system according to claim 1, wherein the end of a first fibre section is coupled to the end of a second fibre section by a connect device.

10. Transmission system according to claim 1, wherein the optical fibre system comprises an input device (C1) and an output device (C2), and the transmission system comprises a polarization rotator (RO) which is associated with the input device or with the output device and enables rotation of the polarizations of the signals transmitted to said optical fibre system by an angle corresponding to the sum of the polarization rotations induced by said optical fibre system, and in opposite direction to the sum of these rotations.
